(19) United States
(12) Patent Application Publication
(10) Pub. No.: US 2019/0329512 A1
(43) Pub. Date: Oct. 31, 2019

(54) CORE MEMBER MADE OF A COMPOSITE PLASTIC MATERIAL, AND METHOD FOR THE PRODUCTION THEREOF

(71) Applicant: Euro-Composites S.A., Echtemach (LU)

(72) Inventors: Rolf Mathias Alter, Echternach (LU); Willy Wintgens, Troisvierges (LU); Darius Kaminski, Ferschweiler (DE)

(21) Appl. No.: 16/462,068

(22) PCT Filed: Nov. 21, 2017
(86) PCT No.: PCT/EP2017/079957

§ 371 Date: May 17, 2019

(30) Foreign Application Priority Data
Nov. 21, 2016 (LU) 93317

(51) Int. Cl. B29D 99/00; B31D 3/02

(52) U.S. Cl. CPC B29D 99/0089; B29K 2105/256; B31D 3/0292; B31D 3/0223

(57) ABSTRACT

Described are a core member having improved mechanical properties as well as a method for the production thereof and a core member produced according to said method.

The present invention relates to a core member having improved mechanical properties. The present invention further relates to a method for producing a core member from an open-cell support, and also to a core member produced according to this method.

Core members made of plastics-material composite play a major role in modern lightweight construction. Such materials make it possible to minimise the material used, and thus lead to a reduction in weight and material costs. This is made possible because such materials permit high mechanical stiffness with low weight. These properties make the materials attractive especially for use in the aerospace industry. Further fields of application are the automotive and shipbuilding industries. With regard to the fundamental properties of core members, reference is made to “Honeycomb Technology: Materials, design, manufacturing, applications and testing”, Tom Bitzer, published by Chapman & Hall, ISBN 0 412 540509.

Because of the preferred use of such materials in lightweight construction, the bulk density of the material is of crucial importance. At the same time, especially good mechanical properties are to be achieved. Materials which have been available hitherto suffer from the disadvantage that especially advantageous mechanical properties, especially in relation to the ratio of modulus of compression to bulk density, can be combined with low bulk densities only within certain limits.

An improvement in the mechanical properties can often be obtained by reducing the cell size of the materials. However, reducing the cell size as a rule also leads to an increase in the bulk density. Thus materials available hitherto suffer from the disadvantage that a low bulk density can be combined with a small cell size only within certain limits.

The aim of the present invention was to provide core members made of a plastics-material composite which are improved with regard to the above-mentioned properties. In addition to the purely synthetically produced plastics materials (such as resins, adhesives and the like), likewise plastics materials which are based on natural resources, inter alia are on the market as bio-resins, such as for example cashew shell oil, from which industrial resins can be produced similarly to a phenol resin, or alternatively furan-containing or -furfural-containing resins, which can be obtained from naturally-based products such as sugar carbohydrates, are not to be excluded from the term “plastics-material composite” mentioned here. The latter examples are quoted by way of example, and do not serve to restrict the protected subject-matter claimed here, but to extend it also to all biologically-based and naturally-based resins, and also resins derived synthetically from natural products, in addition to the purely synthetic resins.

This aim is addressed according to the invention by a core member, wherein the following condition a) is met:
a) it has a bulk density of ≤approximately 48, especially approximately 40, more preferably ≤approximately 32 kg/m³, and very especially preferably ≤26 kg/m³;

and also at least one of the two conditions b1) and b2) is met:
b1) it has a ratio of modulus of compression to bulk density of ≥approximately

$$4.5 \frac{MPa}{kg \text{/} {m}^{3}} ,$$

preferably

$$\geq 5.5 \frac{MPa}{kg \text{/} {m}^{3}} ,$$

and very especially preferably

$$\geq 5.8 \frac{MPa}{kg \text{/} {m}^{3}} ;$$

b2) it has a cell size of ≤approximately 9.6 mm, especially ≤6.4 mm, preferably ≤4 8 mm, especially preferably ≤3.2 mm, and very especially preferably ≤1.6 mm.

Preferably the core member according to the invention meets both conditions b1) and b2). The core members according to the invention are distinguished from the core members known hitherto by a singular combination of properties. Especially, the core members according to the invention have the following properties compared with the core members known from the prior art:
They have a far lower bulk density for the same ratio of modulus of compression to bulk density.
They have a lower bulk density for a higher ratio of modulus of compression to bulk density.
They have the same bulk density for a substantially higher ratio of modulus of compression to bulk density.
They have a far lower bulk density for the same cell size.
They have a lower bulk density for a smaller cell size.
They have the same bulk density for substantially smaller cell sizes.

In one preferred embodiment, the core member according to the invention is configured such that the core member is a honeycomb member, the honeycomb member having a polygonal, preferably a hexagonal, right-angled or circular cell geometry.

It has proved advantageous for the core member according to the invention to be configured such that the core member is produced from (E-glass, S-2-glass) glass fibre, carbon fibre, Kevlar fibre, basalt fibre, preferably a quartz glass fibre, or from hybrid constructions of these named fibres.

In one preferred embodiment, the core member according to the invention is configured such that it is made from a plastics-material composite.

“Core member” in the context of the present invention is to be understood to mean a member which in association with outer layers is used in the core of a composite component, predominantly with the aim of improving the stiffness of this component or alternatively other mechanical or physical (e.g. dielectric) properties, while having a lower weight.

Probably the most frequent core members used in the composites sector include foams (open-cell or closed-cell), honeycomb cores, corrugated cardboard or corrugated sheet, and zigzag geometries derived therefrom (e.g. folded honeycomb) and also materials directly available from nature such as balsa wood.

In one preferred embodiment, the core member according to the invention is a honeycomb member. A “honeycomb member” in the context of the present invention is to be understood to mean a member which has a cellular structure, the cell geometry of which closely resembles a honeycomb. This designation has therefore been derived semantically from it. The cell geometry of a honeycomb member in the context of the present invention is however not restricted solely to hexagonal cell structures.

In one especially preferred embodiment, the core member according to the invention, especially in the form of a honeycomb member, is configured such that it is a plastics-material composite with an open-cell support. In the context of the present invention, the term “open-cell support” is to be understood such that this member is air-permeable, or alternatively may be permeable to any gaseous or alternatively liquid medium.

In one especially preferred embodiment, the support may have a permeability to air in accordance with the measurement method according to DIN EN ISO 9237 (1995), which measures airflow in L/min which flows through the support at a differential pressure of 200 Pa through an area of 20 cm². The permeability to air according to the present invention lies at or above 10 L/dm²/min, and especially preferably far above 716 L/dm²/sec, which currently represents the measuring limit of the measurement method described here.

In one especially preferred embodiment, the core member according to the invention is configured such that the core member is a quartz glass fibre/plastics-material composite.

The core members according to the invention are not subject to any restrictions in principle with regard to the plastics content of the plastics-material composite. It has however proved especially advantageous if the core members according to the invention are configured such that the core member is produced from a plastics material which consists only of a thermoset or alternatively thermoplastic matrix, preferably from the family of cyanate esters or polyimides, optionally also phenols, epoxides, benzoxazines, BMI, polyether imides (PEI), polyether ketones (PEK, PEEK, PAEK, PEKK), polythioethers (PPS), polyethers (PP, PPO), or alternatively from common thermoplastic materials such as PE, PP, PET, PA, PC, PMMA or the like.

Especially good results are achieved if the core member according to the invention is configured such that the core member is a composite consisting of fibres and/or another supporting or filling materials and a plastics material which comprises a thermoset or alternatively thermoplastic matrix, preferably from the family of cyanate esters or polyimides, optionally also phenols, epoxides, benzoxazines, BMI, polyether imides (PEI), polyether ketones (PEK, PEEK, PAEK, PEKK), polythioethers (PPS), polyethers (PP, PPO), or alternatively from common thermoplastic materials such as PE, PP, PET, PA, PC, PMMA or the like. In one especially preferred embodiment, the core member is a composite consisting of fibres and/or other supporting or filling materials and a plastics material which is a cyanate ester.

Especially good results are achieved if the core member according to the invention is configured such that the core member is a quartz glass fibre/cyanate ester composite.

In one especially preferred embodiment, the core member according to the invention is produced from a woven fabric and/or a “fleece”-like structure. In the production of the core members according to the invention, coating or impregnation of the woven fabric by the plastics material takes place. Especially good results are achieved if the core member according to the invention is configured such that the woven fabric is not fully impregnated and/or coated and ensures permeability to air by way of the open-cell cell walls between the cells. This is especially advantageous when the material is used in the aerospace sectors. The background is that permeability to air of the open-cell cell walls results in a pressure compensation with the surroundings becoming possible. This pressure compensation permits problem-free use of the material in surroundings in which greatly reduced pressure prevails, which is frequently the case in the aerospace sector. With core members used hitherto in this sector, it was as a rule necessary to perforate the cell walls in order to permit such a pressure compensation.

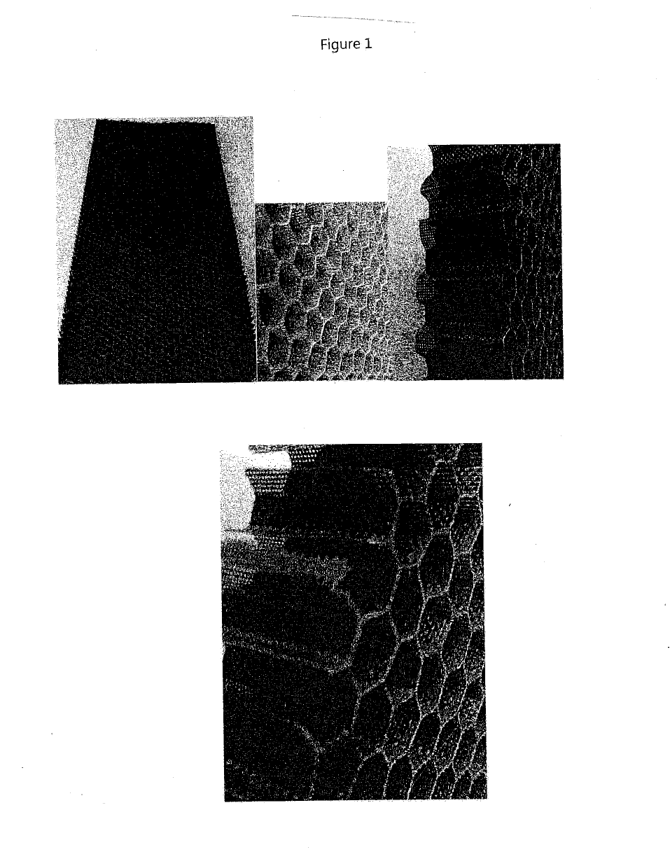

FIG. 1 shows a preferred embodiment of the air-permeable porous honeycomb member according to the present invention.

The thermal stability of the core members plays an important role for many structural applications. In one preferred embodiment, the core members according to the invention are configured such that the core member has a high thermal stability of over 350° C.

The dielectric properties of the material are also of great importance for many applications. Preferably the core members according to the invention are distinguished in that the core member has excellent dielectric properties with a dielectric constant of ≤1.1, especially ≤1.0, and a loss factor (loss tangent) of ≤0.003, especially ≤0.002. Such dielectric properties are advantageous especially in sectors in which the properties of the material in relation to electromagnetic radiation, especially in the radar range, are important.

One further important parameter for many applications is the ratio of compressive strength to bulk density. Preferably the core members according to the invention are embodied such that the core member has a ratio of compressive strength to bulk density of ≥approximately

$$0.04 \frac{MPa}{kg \text{/} {m}^{3}} .$$

The present invention also relates to a method for producing a core member from an open-cell support.

Hitherto, the production of such core members has taken place using what is called the “corrugated” method. In this corrugated method which is known from the prior art, the woven fabric is pre-impregnated with resin. This pre-impregnated material (also referred to as “prepreg”) is then shaped into a form which corresponds to one half of the desired cell geometry, i.e. in the case of a hexagonal honeycomb in the form of a semihexagonal form. In the next step, curing of the prepreg thus shaped takes place. The shaped portions are then bonded together in layers, in order thus to produce a core member.

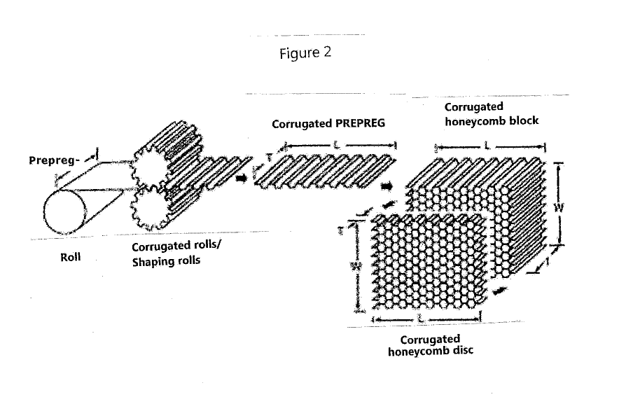

This corrugated method which is known from the prior art is illustrated schematically in FIG. 2.

The core members produced according to this corrugated method which is known from the prior art have the disadvantage that a low bulk density can be combined with an advantageous ratio of modulus of compression to bulk density or with a small cell size only within certain limits.

The aim underlying the invention is achieved by a method for producing a core member from an open-cell supporting material, wherein
i) a material web made of a supporting material is provided with strips of adhesive in regular patterns by means of an application means;
ii) stacks of portions of the material web are formed which lie on one another offset relative to each other with respect to the pattern of strips such
   iia) that the strips of an underneath portion in each case are arranged between the strips of the portion lying thereover in each case;
or
   iib) that the strips of an underneath portion are arranged offset but not centrally between the strips of the portion lying thereover in each case;
iii) portions which lie on one another in each case in the regions of the strips are bonded together to form a stack or alternatively pressed block;
iv) the stack is expanded, with a honeycomb form of whatever polygonal structure forming, especially a honeycomb form of hexagonal, right-angled or circular cell geometry, for producing hexagonal, over-expanded, right-angled and 3D honeycomb cores;
v) the honeycomb form is impregnated and/or coated with a synthetic resin;
vi) the honeycomb form coated with the synthetic resin is subjected to a curing step to cure the synthetic resin;
vii) the honeycomb form thus formed is cut, forming honeycomb members.

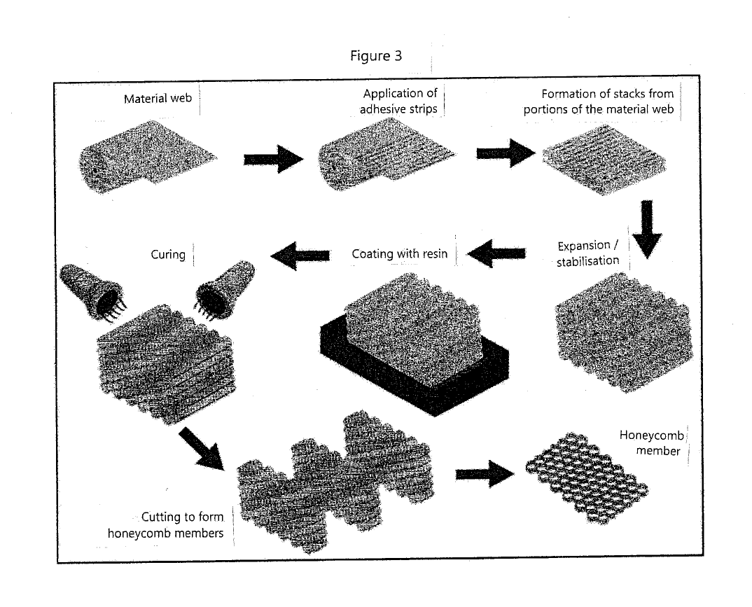

The method according to the invention is described schematically in FIG. 3.

One very significant difference of the method according to the invention compared with the corrugated method known hitherto from the prior art consists in that the impregnation of the supporting material with the synthetic resin takes place only once the honeycomb form has been fully shaped. There had previously been a prejudice among experts which might have prevented the person skilled in the art from taking into account such expansion without prior consolidation and closing-up by means of impregnation, since the production of the honeycomb member by way of an expansion process with highly permeable supports on an industrial scale had previously been held not to be feasible.

One further reason is that a pre-impregnated supporting material (prepreg) is nowadays scarcely suitable for producing a honeycomb if the latter is to be produced by way of the more economic expansion process. A prepreg in its composition would either be too reactive, so that the laid prepreg sheets would bond fully when producing the pressed block, and/or alternatively so hard and brittle that during the expansion process the individual layers are difficult to separate, because the material has become too rigid, locally also bonds and entangles where there are no node glue lines and the expansion stresses therefore become too high, so that the block rips upon expanding.

One further very significant difference of the method according to the invention compared with the corrugated method known hitherto from the prior art is that a extremely highly open-cell support can also be used, which can then be pre-impregnated easily,
the amount of resin being set just so that the porosity of the support is then brought into the range which can be processed for the pressing and expansion process;
the chemical formulation of the resin being adapted by e.g. the addition of additives (inter alia elastomers) in order to make the resin still flexible even once curing is complete and not to allow it to become hard or to embrittle and become brittle;
the resin being pre-reacted in the pre-impregnation process (prepreg process) for the woven fabric to such an extent that upon the pressing operation of the individual layers for producing the pressed block it neither slightly entangles nor bonds immediately prior to the expansion step.

In one preferred embodiment, the method according to the invention is a method for producing a honeycomb member.

With regard to the choice of the open-cell support, the method according to the invention is not subject to any fundamental restrictions. The extent of the porosity however plays a major role—such as the mesh width in the woven fabric—in finding the best-possible process settings. Thus a resin-free support or a slightly impregnated but still porous support can be used as primary material for producing the honeycomb by way of the expansion method.

However, especially advantageous results are achieved if the method according to the invention is configured such that the open-cell support is a woven fabric, preferably but not exclusively consisting of (E-glass, S-2 glass, quartz glass) glass fibre, carbon fibre, Kevlar fibre, basalt fibre, or hybrid woven fabrics of these aforementioned fibres.

Especially advantageously, the method according to the invention can be carried out such that in the honeycomb member the woven fabric is not fully impregnated and ensures permeability to air by way of the open-cell cell walls between the cells.

The method according to the invention is not subject to any restrictions in principle with regard to the adhesive used when bonding the webs of material either. Especially good results are however achieved if a thermoset material, thermoplastic material or alternatively an elastomer, preferably but not exclusively phenol adhesive, epoxy adhesive, polyimide adhesive, cyanate ester adhesive, is used as adhesive.

Astonishingly, it has turned out that it is possible according to the method of the invention to coat the honeycomb form formed in method step iv) with a synthetic resin in step v) without prior stabilisation. The results achieved can however be improved further if stabilisation of the honeycomb form by thermal treatment takes place after the expansion step iv). Such stabilisation of the honeycomb form by thermal treatment preferably takes place at the softening point of thermoplastic materials or at (or optionally also slightly below) the glass transition temperature (TG) of thermoset materials. In the case of TG-free thermoset materials, thermal treatment at or above the curing temperature can also briefly lead to softening of the resin and hence then to the thermal forming.

The duration of the thermal treatment may in the case of direct contact with the substrate be several seconds to minutes, such as in the punching or shaping method. In the case of large-volume members through which hot air flows or which are exposed to hot air for tempering, or members which have a large mass and/or heat capacity, the heat treatment may last for several minutes to several hours.

Ultimately, the temperature and the time of the heat treatment is dependent on the chemical composition, the geometry and also on the hot-deformation stabilisation process.

The method according to the invention is not subject to any restrictions in principle with regard to the synthetic resin used. It has however turned out that especially good results are achieved if a thermoset or alternatively thermoplastic matrix system is used as synthetic resin, preferably from the family of cyanate esters or polyimides, optionally also phenols, epoxides, benzoxazines, BMI, polyether imides (PEI), polyether ketones (PEK, PEEK, PAEK, PEKK), polythioethers (PPS), polyethers (PP, PPO), or alternatively from common thermoplastic materials such as PE, PP, PET, PA, PC, PMMA or the like. In one especially preferred embodiment, a cyanate ester is used as synthetic resin.

The method according to the invention is preferably carried out such that steps v) and vi) are repeated one or more times, in order to apply one or more further layers of the synthetic resin. Such repetition of steps v) and vi) makes it possible on one hand to increase the stability of the honeycomb member, but on the other hand also results in an increase in the bulk density. The person skilled in the art will therefore, dependent on the desired properties of the honeycomb member produced according to the method of the invention, choose whether steps v) and vi) are to be repeated once or several times.

The present invention also relates to a core member produced according to the method described above, especially in the form of a honeycomb member.

Preferably, the core member produced according to the method of the invention is distinguished in that the open-cell support is not fully impregnated and/or coated and ensures permeability to air by way of the open-cell cell walls between the cells.

Preferably the core member produced according to the method of the invention is designed such that the core member has a ratio of modulus of compression to bulk density of ≥approximately

$$5.5 \frac{MPa}{kg \text{/} {m}^{3}} ,$$

and especially preferably of ≥approximately

$$5.8 \frac{MPa}{kg \text{/} {m}^{3}} .$$

One further important parameter for many applications is the ratio of compressive strength to bulk density. Preferably the core members according to the invention are embodied such that the core member has a ratio of compressive strength to bulk density of ≥approximately

$$0.04 \frac{MPa}{kg \text{/} {m}^{3}} .$$

In one especially preferred embodiment, the core member produced according to the method of the invention is distinguished in that the core member, in addition to the mechanical properties described, has excellent dielectric properties, with a dielectric constant of ≤1.1, especially ≤1.0, and a loss factor (loss tangent) of <0.003, especially <0.002.

The present invention will be explained in greater detail below:

According to the embodiment of the invention preferred here, a honeycomb member was produced consisting of a quartz glass woven fabric and a cyanate ester resin, with a compressive modulus of around 275 MPa and a compressive strength of around 1.2 MPa being achieved for a cell size of 6.4 mm and a density of 32 kg/m³.

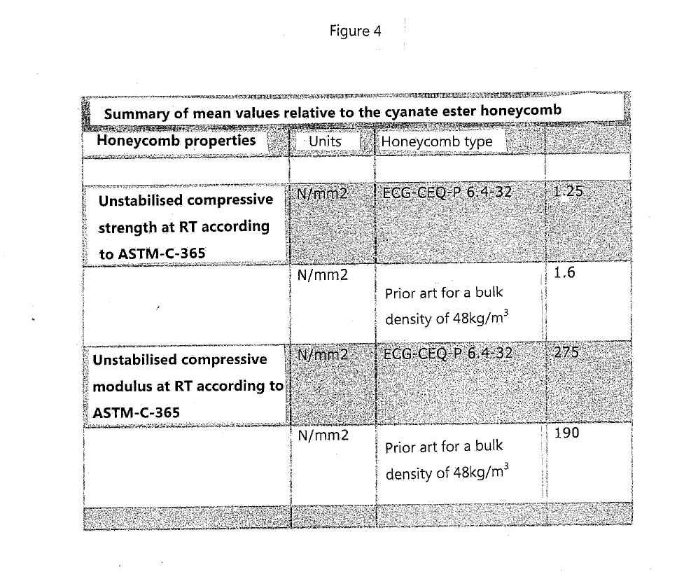

FIGS. 4 to 12 clearly show that the prior art scarcely achieves a comparable compressive modulus, or can achieve a comparable compressive strength merely only at high density.

In FIGS. 4 to 12 the honeycomb designation
ECG-CEQ P-6.4-32

stands for a glass fibre honeycomb manufactured with Quartz glass and Cyanate Ester resin with a cell size of 6.4 mm and a bulk density (BD, density) of 32 kg/m³. The P indicates that the cell crosspieces of the honeycomb are porous/air-permeable. It is usual for this porosity to be introduced mechanically into the cell walls by a perforation. In this embodiment of the invention preferred here, this porosity was however naturally generated by means of an adapted selection of the support and of the resin, with the resin not completely consolidating the support upon coating.

The table shown in FIG. 4 shows the properties of such a honeycomb.

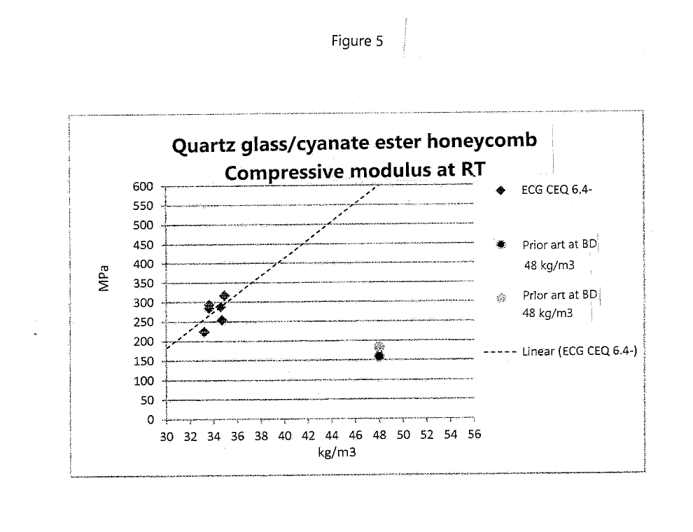

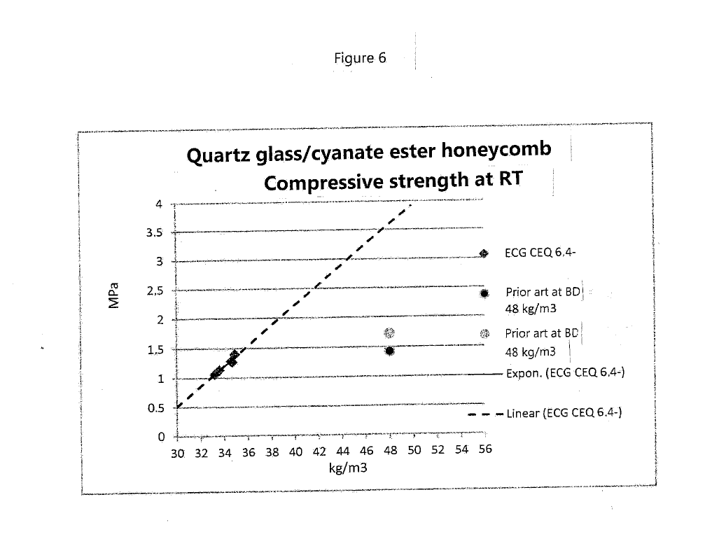

FIGS. 5 and 6 show the measurement results for compressive modulus and compressive strength plotted on a graph.

With reference to these mechanical values, compared with the prior art the ratio of compressive modulus to density (or bulk density—BD) is at a substantially higher value of

$$> 5.5 \frac{MPa}{kg \text{/} {m}^{3}} ,$$

preferably

$$> 5.8 \frac{MPa}{kg \text{/} {m}^{3}} ,$$

which ultimately results in high stiffness in the core, which until today is singular for a low bulk density of 26-48 kg/m³.

In the modification of the present invention preferred here, the ratio of compressive modulus to bulk density is between 6 and

$$10 \frac{MPa}{kg \text{/} {m}^{3}}$$

for a density of 32 kg/m³, and may even be around a value of

$$12 \frac{MPa}{kg \text{/} {m}^{3}}$$

for a density or us Kg/m³. Compared with the prior art, this value for a BD of 48 kg/m³ is merely at most

$$4 \frac{MPa}{kg \text{/} {m}^{3}} .$$

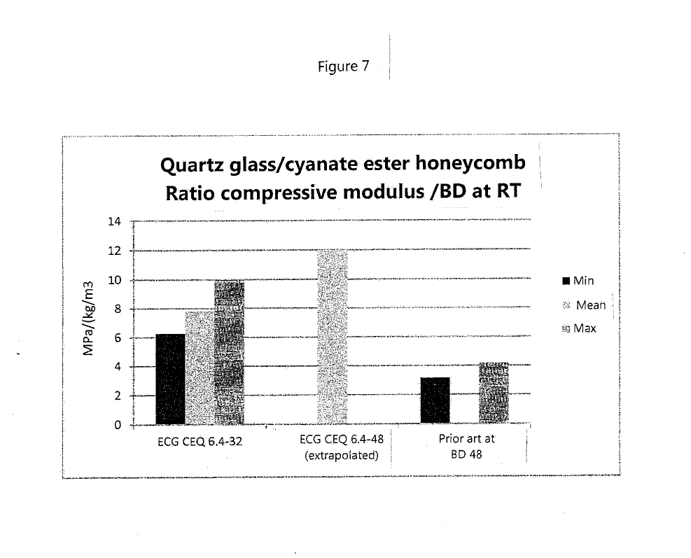

This is shown in FIG. 7.

Likewise, with reference to these mechanical values, compared with the prior art also the ratio of compressive strength to density (or bulk density—BD) at a value of 0.03 to

$$0.047 \frac{MPa}{kg \text{/} {m}^{3}}$$

is even slightly higher than the prior art, and this for a lower density of 32 kg/m³ compared with 48 kg/m³. On this point it then further is to be recognised that for an equivalent density (bulk density) of 48 kg/m³ this ratio of compressive strength to density has a substantially higher value of around

$$0.07 \frac{MPa}{kg \text{/} {m}^{3}}$$

compared with the prior art, which is at most around

$$0.035 \frac{MPa}{kg \text{/} {m}^{3}} .$$

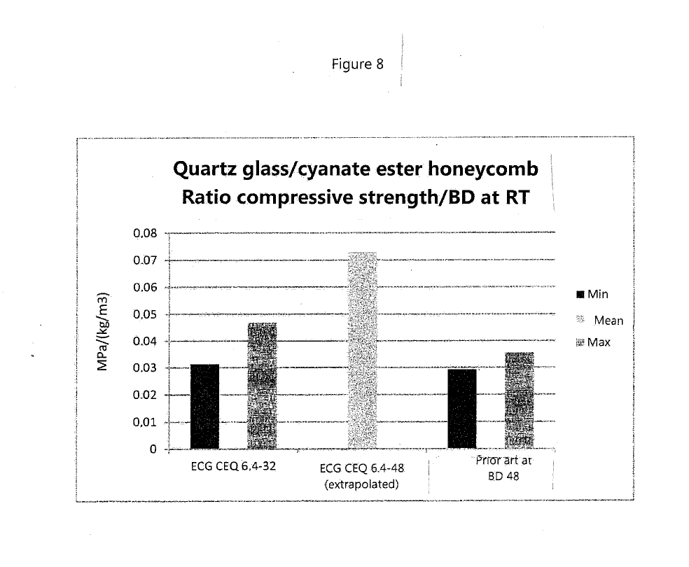

This is shown in FIG. 8.

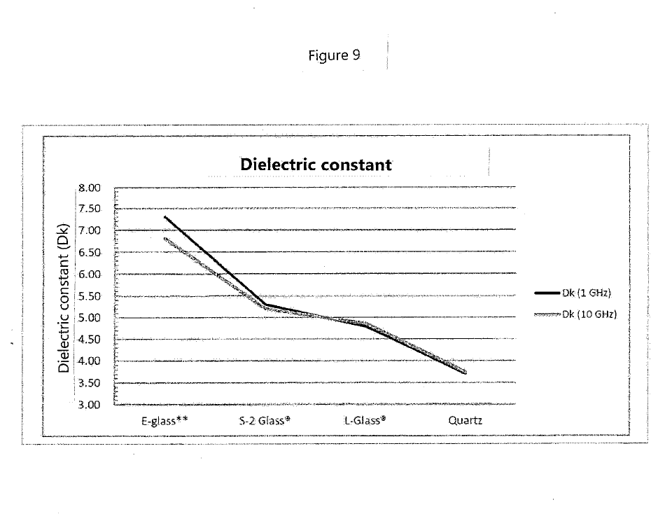

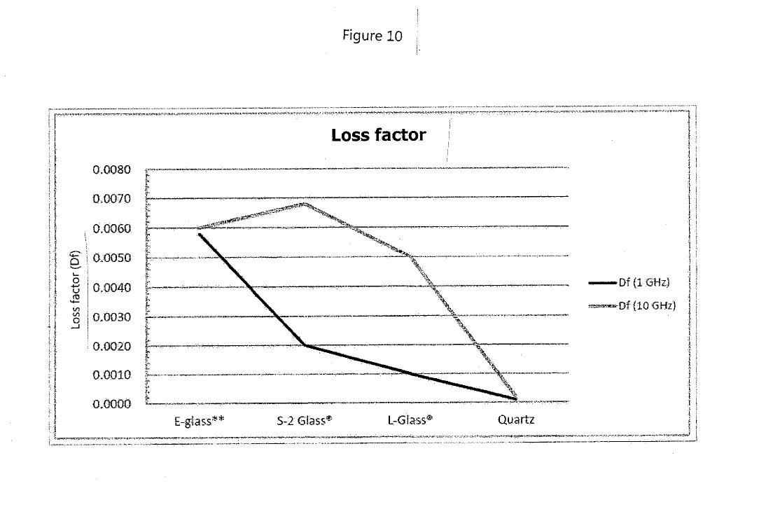

Furthermore, the honeycomb according to the embodiment of the present invention preferred here, in addition to the mechanical properties has excellent dielectric values, which are to be inferred because of the raw materials used here such as cyanate esters and quartz glass. This is shown in FIGS. 9 and 10. The cyanate ester resin is multifunctional resin systems, the functional groups of which are set accordingly in order to achieve the mechanical modulus/strength values and dielectric values described here.

As far as the glass fibre type is concerned, the quartz glass fibre represents the best requirements for achieving the lowest possible dielectric values.

The cyanate ester resin can be used in addition to other resin systems, such as the polyimide and even also thermoplastic materials PE, PP, PEEK (and derivatives), fluorine-containing materials (such as inter alia ETFA, PTFE and the like), which likewise in the form of films or alternatively laminates as well have extremely low dielectric values.

As far as the embodiment of the present invention which is preferred here is concerned, the base component of the cyanate ester resin consists of a 2-functional cyanic acid ester, which under the action of temperature cyclotrimerises in an annular structure and forms a triazine ring. This reaction is triggered at a temperature of at least 165° C. Depending on the addition of catalysts, this temperature can also be substantially reduced.

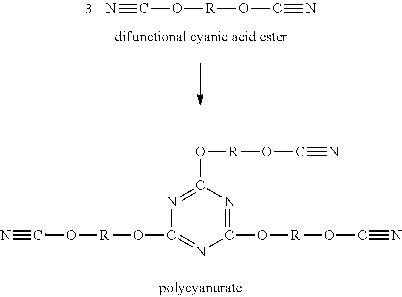

What is crucial for good cross-linking of the resin is to find curing cycles which take place after each dipping operation of the honeycomb member.

Ultimately, it must be guaranteed that the resin is cured fully, no residual reactivity occurs and a thermal stability of around 400° C. is achieved.

As far as the reactivity is concerned, there is only little experience in the processing of non-catalysed or only slightly catalysed cyanate ester systems. What is problematic here is to estimate the reaction speed and the temperatures which have to act on the resin in order to achieve complete curing.

Especially good results were achieved by selecting suitable curing cycles as follows:
between the individual coating steps a lower curing temperature is operated in order partially to cure the applied layer, which makes it possible for each new coating layer of resin to bind optimally to the partially cured layer thereunder. This curing temperature lies at the lowest possible curing temperature of the resin. The temperature cycle for achieving this reaction temperature may (but does not have to) be designed as a multi-stage one, so that at optimum requirement the temperature is not achieved in one heating-up operation.
after the last coating step, a complete curing cycle is carried out stepwise up to and above the desired temperature at which ultimately the heat resistance is demanded, in this case 400° C.

To achieve this heat resistance, the last temperature stage does play an essential role, but the entire production method with the different curing cycles and intermediate stages alone guarantee optimal cross-linking of the coating layers.

Further, of course the solids content and the solvent (usually ketone-containing solvents such as acetone, MEK, -butanone, cyclohexanone, diisopropyl ketone and the like) and also the application amount upon each coating and also the actual resin formulation also play a likewise essential role in order to attain the result of this high thermal stability. The solids content of the solution used here is 20-70%, but then preferably 40-60%.

It is likewise possible to admix further chemicals such as but not exclusively epoxy-containing components for further functionalisation and changing the range of properties of the resin.

Further measurements, such as thermogravimetric analysis, have shown that, taking into consideration the adapted resin formulation previously described and the coating and curing process, a substantial increase in the thermal stability was achieved.

According to the modification of the present invention preferred here, a substantial change in the resin does not take place until a temperature of 400° C., compared with the prior art, in which this change already takes place at 300° C.

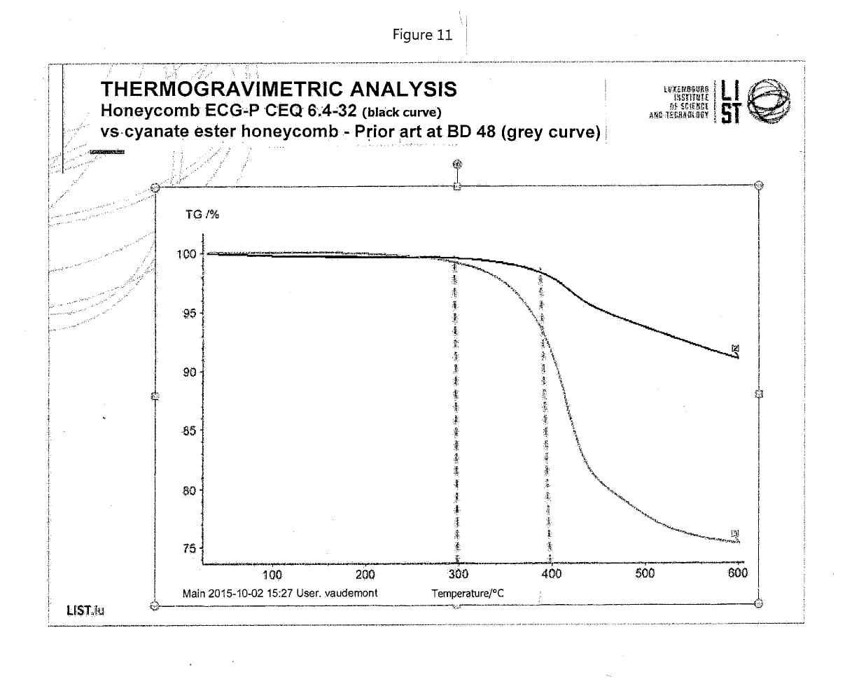

FIG. 11 shows a TGA (thermogravimetric) measurements for measuring the thermal stability.

One further aspect is that the test piece under the influence of extreme temperatures and vacuum conditions which are specified according to test standard ECSS-Q-ST-70-02C does not result in outgassing products. The latter is especially important in critical applications in the space sector, since this outgassing may be disruptive in the transmission of data or the like.

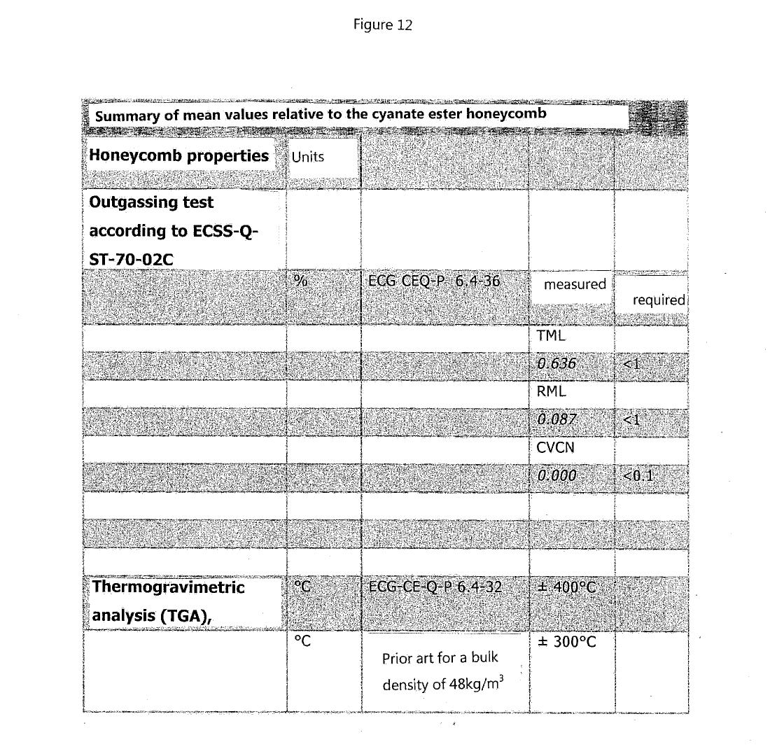

The table shown in FIG. 12 summarises the results achieved here.

One further important component of the present invention comprises in configuring an open-cell honeycomb member by optimally designing the ratio of resin to support.

The latter is however also dependent on the porosity structure (e.g. in the case of woven fabric the weave style) and on the flow characteristics and viscosity behaviour of the matrix system during application and also during curing, so that a resin content of 5-60 wt. %, preferably 5-80 wt. %, is observed. In the embodiment of the invention preferred here, the resin content is 10-20 wt. %, preferably 9-21 wt. %.

By means of thin-bodied low-viscosity matrix systems of 100 to 1000 mPas (cps), permeability to air and porosity can be achieved even also with high application proportions of matrix. The latter is virtually independent of the mesh width of the woven fabric, but merely dependent on the viscosity and the flow behaviour of the resin and the application amount upon each coating operation. In the embodiment of the present invention preferred here, woven fabric structures with a porosity of 2-40% and a mesh width of 100-800 micrometres were used. Without restricting the latter more greatly, a preferred modification relates to a porosity of 20-30% and a mesh width of 200-500 micrometres.

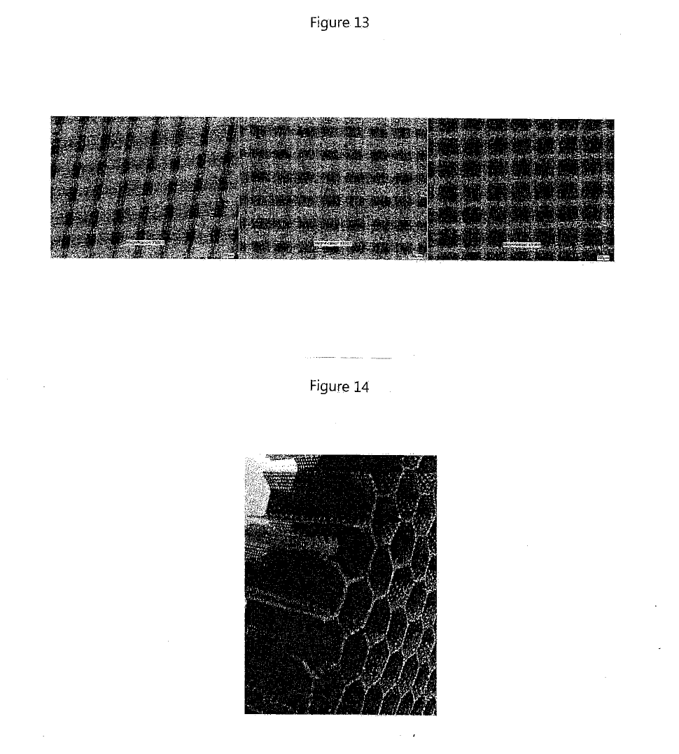

FIG. 13 shows microscope images of woven fabrics of different porosity and mesh width.

With higher-viscosity matrix systems, this porosity and permeability to air after coating can also be preserved with matrix systems up to a viscosity of 3000 cps. The latter is then also again dependent on the open-cell character of the supporting material—in the case of the woven fabrics the mesh width—which can be defined inter alia by way of the permeability to air.

A woven fabric with a high porosity of 40% and or with a large mesh width of 300-800 micrometres (with large pores) can be coated with matrix systems which are in the higher viscosity range, i.e. of around 3000 cps, without the pores closing up fully after coating and curing.

Especially in the case of high porosities, a further preferred embodiment of the invention comprises in partially impregnating the open-cell support, optionally the woven fabric, prior to production of the honeycomb in order to decrease the open-cell character and to simplify further processing after the production process of the expansion method described here.

Upon pre-impregnating, generally the support or the woven fabric is preferably partly consolidated at high porosity with a resin mixture, in a weight ratio to the pure support weight of 10-75 wt. %. Preferably the weight ratio is 40-60 wt. %. This resin mixture may be resins which are based on a thermoset and/or alternatively thermoplastic matrix system, preferably from the family of cyanate esters or polyimides, optionally also phenols, epoxides, benzoxazines, BMI, polyether imides (PEI), polyether ketones (PEK, PEEK, PAEK, PEKK), polythioethers (PPS), polyethers (PP, PPO), or alternatively from current thermoplastic materials such as PE, PP, PET, PA, PC, PMMA or the like. In one especially preferred embodiment, a cyanate ester is used as synthetic resin.

These resin mixtures may comprise several of the matrix systems given above, with the aim of obtaining an elastic resin bond which makes the woven fabric elastic and flexible even after the pre-coating/impregnation and optionally subsequent curing.

Further, these resin mixtures may also have solvents and additives added to them, the additives possibly being elastomers in order to flexibilise the resin, or alternatively cross-linking agents, hardeners and/or catalysts, in order to cross-link the resin fully and then also to make it temperature-stable. The latter may be important in producing the bonded stack—also referred to as “pressed block”—in order at high temperatures of e.g. 150° C. up to 250° C. and at a pressure of 5 bar up to 100 bar to avoid inter-layer bonding being produced only at the linear node glue during the bonding process proper and no full-surface bonding or entanglements occurring between the individual layers. The latter may result in the expansion process not being realisable.

The flexibility of the support or optionally of the woven fabric guarantees expansion of the block without the support ripping or excessively high expansion forces having to be applied in order to separate the individual layers from one another. At excessively high expansion forces, the individual layers become detached completely from one another, since the node glue is unable to withstand these forces and therefore becomes detached adhesively or alternatively cohesively from the supporting material, which immediately results in complete breaking of the honeycomb block.

FIG. 14 shows once again an image illustrating a porous, not completely impermeably coated honeycomb member.

The present invention is however not limited only to honeycombs and core members in general which comprise a permeability to air and/or porosity, but also relates to fully coated core members. The porous modification merely represents a separate form of the present invention, with a not fully coated and porous modification ultimately from a mechanical point of view representing the rather weaker modification, with which then nevertheless mechanical characteristic values (here especially compressive strength and compressive moduli) which are above those of the prior art are achieved.

One further preferred feature of the present invention comprises in defining more precisely a honeycomb member comprising a support impregnated or coated with resin, the term “resin” being interpreted in a broader sense and relating substantially to thermoset and thermoplastic plastics material systems.

The term “comprising” within the scope of the present invention may also mean “consisting of”.

The support impregnated with resin preferably forms the cell crosspieces of the core member or honeycomb member, an essential aim of the present invention being to construct a honeycomb member with thin-walled and lightweight cell crosspieces: the latter can be determined precisely by way of the weight per unit area of the coated support which forms the cell crosspiece of the core member or here of the honeycomb.

In the case of a hexagonal cell geometry, which is one of the preferred version of the present invention, the BD (bulk density) of the honeycomb can be calculated by way of the WUA (weight per unit area) of the support with resin and the cell size as follows:

BD (honeycomb)=4/3*2/cell size*WUA(support+resin)

Other cell structures, cylindrical, over-expanded and also the 3D structure of the honeycomb, are calculated in similar manner. Without going into detail about further calculations, this mathematical formula given here for calculating bulk density of the honeycomb with the weight per unit area of the impregnated or coated support can be used even in the case of changed cell geometries with an accuracy of around 20-25%.

A fundamental aim of the present invention comprises of producing core members e.g. in the form of honeycomb member in a BD range (BD=bulk density) of 26-48 kg/m³, and this with a cell width of 1.6 to 9.6 mm.

An essential aim of the present invention is for these core members to have high mechanical properties in relation to the bulk density. What is essential is a compressive modulus to bulk density of

$$\geq 4.5 \frac{MPa}{kg \text{/} {m}^{3}} ,$$

preferably

$$\geq 5.5 \frac{MPa}{kg \text{/} {m}^{3}} ,$$

especially preferably

$$\geq 5.8 \frac{MPa}{kg \text{/} {m}^{3}} ,$$

which may even very especially preferably reach

$$12 \frac{MPa}{kg \text{/} {m}^{3}} .$$

Further, likewise also the ratio of compressive strength to bulk density of

$$0.03 \frac{MPa}{kg \text{/} {m}^{3}} to 0.047 \frac{MPa}{kg \text{/} {m}^{3}} ,$$

preferably

$$0.06 \frac{MPa}{kg \text{/} {m}^{3}} ,$$

which may even also especially preferably reach

$$0.07 \frac{MPa}{kg \text{/} {m}^{3}} .$$

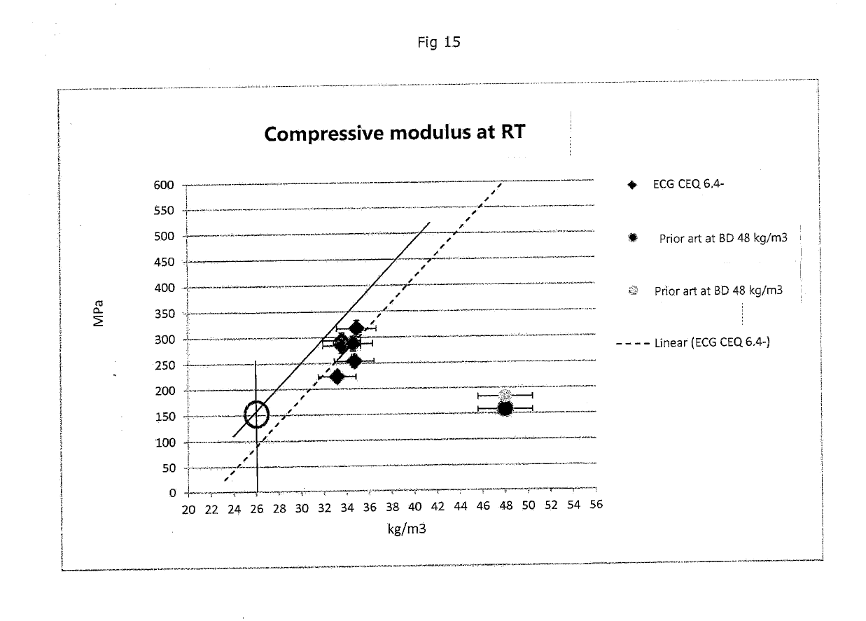

That in principle also these high mechanical properties can be achieved for a low density of 26 kg/m³ is proved by FIG. 15.

Here it becomes apparent that within a measuring tolerance of 5%, which is permissible experimentally, a compressive modulus of 150 N can also be achieved for a low bulk density of the honeycomb of 26 kg/m³. In FIG. 15, this range is identified by way of the range of extrapolated values marked in a circle. Accordingly, then a ratio of compressive modulus to bulk density of

$$5.5 \frac{MPa}{kg \text{/} {m}^{3}} ,$$

preferably

$$5.8 \frac{MPa}{kg \text{/} {m}^{3}} ,$$

can still be achieved even with this low BD of 26 kg/m³.

One further preferred feature of the present invention comprises in producing this honeycomb member preferably but not imperatively by way of an expansion process.

Below, preferred embodiments of honeycomb members and cell sizes are given, with the tolerances with regard to the cell size and BD of the honeycomb usually being ±10%. The weights per unit area calculated here for the impregnated support of the honeycomb are therefore in a tolerance range of around ±10 to 25%, preferably ±20%.

The upper weight per unit area range of the impregnated support which forms the honeycomb crosspiece is calculated from a honeycomb with the greatest cell width and the maximum bulk density for this cell width of 40 kg/m³.
For a honeycomb member with a cell width of 9.6 mm and a BD of 40 kg/m³, the impregnated support which forms the crosspieces of the honeycomb member has a weight per unit area of 144 g/m².

The lower weight per unit area range of the impregnated support which forms the honeycomb crosspiece is calculated from a honeycomb with the smallest cell size and the lowest bulk density here of 26 kg/m³.
For a honeycomb member with a cell width of 1.6 mm and a BD of 26 kg/m³, the impregnated support which forms the crosspieces of the honeycomb member has a weight per unit area of 15.6 g/m².

The following examples are further embodiments of the present invention, depending on cell size and honeycomb bulk density, which are preferably taken into account.

For a honeycomb member with a cell size of 9.6 mm and a BD of 26 to 40 kg/m³, the impregnated support preferably has a weight per unit area of 144 to 94 g/m².

For a honeycomb member with a cell size of 9.6 mm and a BD of 40 kg/m³, the impregnated support preferably has a weight per unit area of 144 g/m².

For a honeycomb member with a cell size of 9 6 mm and a BD of 32 kg/m³, the impregnated support preferably has a weight per unit area of 115 g/m².

For a honeycomb member with a cell size of 9 6 mm and a BD of 26 kg/m³, the impregnated support preferably has a weight per unit area of 94 g/m².

For a honeycomb member with a cell size of 6.4 mm and a BD of 26 to 48 kg/m³, the impregnated support preferably has a weight per unit area of 115 to 62 g/m².

For a honeycomb member with a cell size of 6 4 mm and a BD of 48 kg/m³, the impregnated support preferably has a weight per unit area of 115 g/m².

For a honeycomb member with a cell size of 6.4 mm and a BD of 40 kg/m³, the impregnated support preferably has a weight per unit area of 96 g/m².

For a honeycomb member with a cell size of 6.4 mm and a BD of 32 kg/m³, the impregnated support preferably has a weight per unit area of 77 g/m².

For a honeycomb member with a cell size of 6.4 mm and a BD of 26 kg/m³, the impregnated support preferably has a weight per unit area of 62 g/m².

For a honeycomb member with a cell size of 4.8 mm and a BD of 26 to 48 kg/m³, the impregnated support preferably has a weight per unit area of 86 to 47 g/m².

For a honeycomb member with a cell size of 4.8 mm and a BD of 48 kg/m³, the impregnated support preferably has a weight per unit area of 86 g/m².

For a honeycomb member with a cell size of 4 8 mm and a BD of 40 kg/m³, the impregnated support preferably has a weight per unit area of 72 g/m².

For a honeycomb member with a cell size of 4.8 mm and a BD of 32 kg/m³, the impregnated support preferably has a weight per unit area of 57 g/m².

For a honeycomb member with a cell size of 4.8 mm and a BD of 26 kg/m³, the impregnated support preferably has a weight per unit area of 47 g/m².

For a honeycomb member with a cell size of 3.2 mm and a BD of 26-48 kg/m³, the impregnated support preferably has a weight per unit area of 57 to 31 g/m².

For a honeycomb member with a cell size of 3.2 mm and a BD of 48 kg/m³, the impregnated support preferably has a weight per unit area of 57 g/m².

For a honeycomb member with a cell size of 3.2 mm and a BD of 40 kg/m³, the impregnated support preferably has a weight per unit area of 48 g/m².

For a honeycomb member with a cell size of 3.2 mm and a BD of 32 kg/m³, the impregnated support preferably has a weight per unit area of 38 g/m².

For a honeycomb member with a cell size of 3.2 mm and a BD of 26 kg/m³, the impregnated support preferably has a weight per unit area of 31 g/m².

For a honeycomb member with a cell size of 1.6 mm and a BD of 26 to 48 kg/m³, the impregnated support preferably has a weight per unit area of 29 to 15 g/m².

For a honeycomb member with a cell size of 1.6 mm and a BD of 48 kg/m³, the impregnated support preferably has a weight per unit area of 29 g/m².

For a honeycomb member with a cell size of 1.6 mm and a BD of 40 kg/m³, the impregnated support preferably has a weight per unit area of 24 g/m².

For a honeycomb member with a cell size of 1.6 mm and a BD of 32 kg/m³, the impregnated support preferably has a weight per unit area of 19 g/m².

For a honeycomb member with a cell size of 1.6 mm and a BD of 26 kg/m³, the impregnated support preferably has a weight per unit area of 15.6 g/m².

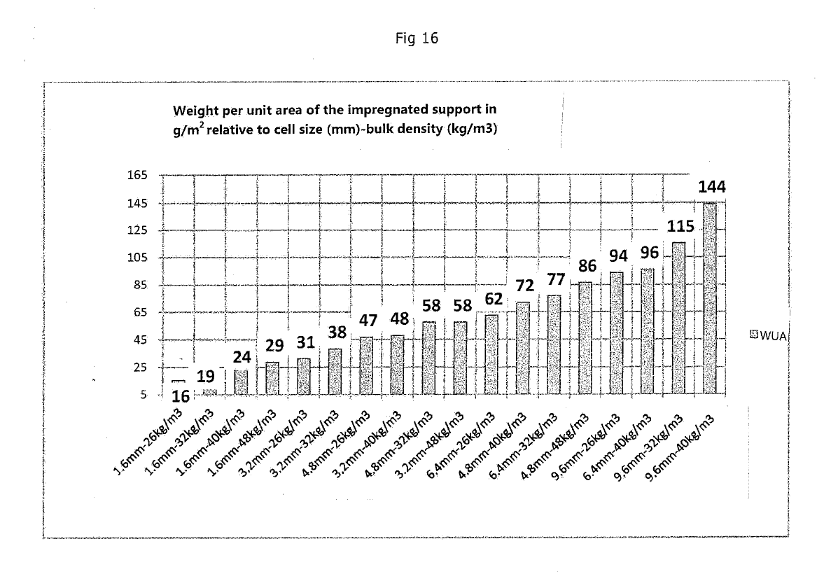

FIG. 16 shows an illustration in graph form of these embodiments previously given, in which the weights per unit area of the coated support in the honeycomb is given relative to the honeycomb types and indicating the cell size and the bulk densities.

The weight per unit area of the non-impregnated support (gross weight of the support) which forms the honeycomb crosspieces, and which according to the present invention is used as starting material, is dependent on the weight content of the coating on the support.

This weight content of the coating, often also called resin content, is preferably between 5 and 60 wt. %, especially preferably between 5 and 80 wt. %.

Without restriction to the scope of the present invention, in one preferred embodiment of the present invention the support has a gross weight of 60 to 70 g/m² for a honeycomb with a cell size of 6.4 mm and a bulk density of 32 kg/m³.

The resin content—weight content of the resin on the support can be calculated as follows:

Gross bulk density of the block of uncoated/unprocessed support according to the formula given above: 4/3*2/6.4*60 to 4/3*2/6.4*70=25 to 29 kg/m³.

The bulk density of the block after impregnation with the coated support is 32 kg/m³ From this data, the weight of resin in the block (without support) is calculated as follows:

32-25 to 32−29=3 to 7 kg/m³,

and the resin content in the block relative to the weight of the coated support is then between 3/32 to 7/32=9 to 21 wt. %.

According to the weight per unit area given here of the impregnated support of 16 to 144 g/m² and a resin content of 5 wt. % to 80 wt. %, the unprocessed uncoated support as starting material may lie in a weight range of between: 3 g/m² and 137 g/m² of in the block likewise in a tolerance range of ±20%.

### Explanation of Abbreviations and Specialist Terms

Cell dimension, cell width and cell size have the same meaning
Compressive strength and compression strength have the same meaning
Compressive modulus and modulus of compression have the same meaning
A stack or stacked honeycomb block produced after the deposition process of the support layers is also called “pressed block” after the gluing operation
WUA stands for weight per unit area
BD stands for bulk density

1. A core member, wherein the following condition a) is met:
a) it has a bulk density of ≤approximately 48;
and also at least one of the two conditions b1) and b2) is met:
b1) it has a ratio of modulus of compression to bulk density of ≥approximately
$$4.5 \frac{MPa}{kg \text{/} {m}^{3}} ;$$
b2) it has a cell size of ≤approximately 9.6 mm.

2. The core member of claim 1, wherein the core member is a honeycomb member, the honeycomb member having a polygonal right-angled or circular cell geometry.

3. The core member of claim 1, wherein core member is produced from (E-glass, S-2-glass) glass fibre, carbon fibre, Kevlar fibre, basalt fibre, quartz glass fibre, or from hybrid constructions of these named fibres.

4. The core member of claim 1, wherein the core member is a quartz glass fibre/plastics-material composite.

5. The core member of claim 1, wherein the core member is produced from a plastics material which comprises a thermoset or alternatively thermoplastic matrix.

6. The core member of claim 1, wherein the core member is a composite consisting of fibres and/or another supporting or filling materials and a plastics material which comprises a thermoset or alternatively thermoplastic matrix.

7. The core member of claim 1, wherein the core member is produced from a woven fabric and/or a fleece-like structure.

8. The core member according to claim 7, wherein the woven fabric is not fully impregnated and/or coated and ensures permeability to air by way of the open-cell cell walls between the cells.

9. The core member of claim 1, wherein the core member has a high thermal stability of over 350° C.

10. The core member of claim 1, wherein the core member has excellent dielectric properties with a dielectric constant of ≤1.1, and a loss factor (loss tangent) of <0.003.

11. The core member of claim 1, wherein the core member has a ratio of compressive strength to bulk density of ≥approximately
$$0.04 \frac{MPa}{kg \text{/} {m}^{3}} .$$

12. A method for producing a core member from an open-cell supporting material, wherein
i) a material web made of a supporting material is provided with strips of adhesive in regular patterns by means of an application means;
ii) stacks of portions of the material web are formed which lie on one another offset relative to each other with respect to the pattern of strips such
iia) that the strips of an underneath portion in each case are arranged between the strips of the portion lying thereover in each case;
or
iib) that the strips of an underneath portion are arranged offset but not centrally between the strips of the portion lying thereover in each case;
iii) portions which lie on one another in each case in the regions of the strips are bonded together;
iv) the stack is expanded, with a honeycomb form of whatever polygonal structure forming, especially a honeycomb form of hexagonal, right-angled or circular cell geometry, for producing hexagonal, over-expanded, right-angled and 3D honeycomb cores;
v) the honeycomb form is impregnated and/or coated with a synthetic resin;
vi) the honeycomb form coated with the synthetic resin is subjected to a curing step to cure the synthetic resin;
vii) the honeycomb form thus formed is cut, forming honeycomb members.

13. The method according to claim 12, wherein the open-cell support is a woven fabric and/or a fleece-like structure.

14. The method according to claim 13, wherein the support is partly pre-impregnated or coated with a resin in order to reduce the porosity prior to the expansion process, with the porosity after the coating being less than 40% and the coating being in a weight ratio of 10-75% relative to the support weight and the coated support after the coating and optionally curing being thermally stable at 160-250° C. and made flexible, in order to implement the forming of these pre-impregnated layers during the expansion process with low expansion forces.

15. The method according to claim 13, wherein the support in the form of the honeycomb member is not fully impregnated and/or coated with a resin and ensures permeability to air by way of the open-cell cell walls between the cells.

16. The A method according to claim 12, wherein a thermoset material, thermoplastic material or alternatively an elastomer is used as adhesive.

17. The method according to claim 12, wherein after the expansion step iv) stabilization of the honeycomb form by thermal treatment takes place.

18. The method according to claim 12, wherein a thermoset or alternatively thermoplastic matrix system is used as resin.

19. The method according to claim 12, wherein steps v) and vi) are repeated one or more times, in order to apply one or more further layers of the synthetic resin.

20. A core member, produced according to the method according to claim 12.

21. The core member according to claim 20, wherein the open-cell support is not fully impregnated and/or coated and ensures permeability to air by way of the open-cell cell walls between the cells.

22. The core member according to claim 20, wherein the core member has excellent dielectric properties with a dielectric constant of ≤1.1 and a loss factor (loss tangent) of <0.003.

23. The core member according to claim 20, wherein the core member has a ratio of modulus of compression to bulk density of ≥approximately
$$5.5 \frac{MPa}{kg \text{/} {m}^{3}} .$$
